(19) United States
(12) Patent Application Publication
(10) Pub. No.: US 2014/0251994 A1
(43) Pub. Date: Sep. 11, 2014

(54) DEVICE FOR PROVIDING TREATMENT TO A FOUNTAIN DRINK DISPENSER

(71) Applicant: INTERCON CHEMICAL COMPANY, St. Louis, MO (US)

(72) Inventors: Thomas Worth, Raleigh, NC (US); James Epstein, St. Louis, MO (US); Paul Bradley Forrest, Cary, NC (US)

(73) Assignee: INTERCON CHEMICAL COMPANY, St. Louis, MO (US)

(21) Appl. No.: 13/792,150

(22) Filed: Mar. 10, 2013

(51) Int. Cl. A47J 31/60

(52) U.S. Cl. CPC A47J 31/60
USPC 220/87.1

(57) ABSTRACT

A device for use with a drink dispenser is disclosed herein. The device includes an insert having one or more treatment characteristics and that is sized to be received within a trough of a drink dispenser and a panel engaged with the insert. The panel defines a plurality of apertures that allow flowthrough of spilled liquid from the drink dispenser into the insert.

### TECHNICAL FIELD

This disclosure is directed towards a device for providing treatment to a fountain drink dispenser, and, more particularly, towards an insert sized to be received within a trough of a fountain drink dispenser and having one or more liquid soluble treatment materials configured for applying a treatment to the fountain drink dispenser trough.

### BACKGROUND

Fountain drink dispensers are used in restaurants and similar locations and establishments for dispensing a selected one of a variety of drinks for consumption by a purchaser. For example, a drink dispenser may have one of a plurality of drink choices with each dispenser having an individual dispensing nozzle. A user selects a desired drink to be dispensed by pushing their cup or container proximal to a dispensing lever associated with a desired drink and the dispenser then dispenses the drink into the cup or container.

The drinks dispensed are typically sugar-based, with carbonated soda drinks and alcoholic beverages such as beer being commonly dispensed with drink dispensers. When these sugar-based drinks are spilled into the trough of the fountain drink dispenser, the sugar-based drinks will tend to ferment and otherwise produce an undesirable odor. This is further pronounced when liquid collects in the outlet drain pipe assembly and odor builds up due to aging of the sugar-based drinks

Cleaning these dispensers is difficult to do and requires frequent attention. Without frequent cleaning, odors emanate from the trough and/or drain pipe assembly. This is problematic in the restaurant industry.

Accordingly, one or more devices and methods for providing aromatic and other treatment to a fountain drink dispenser.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein is a device for use with a fountain drink dispenser. The device includes an insert having one or more treatment characteristics and that is sized to be received within a trough of a fountain drink dispenser, and a panel engaged with the insert and defining a plurality of apertures that allow flowthrough of spilled liquid from the fountain drink dispenser into the insert. The insert may be liquid soluble.

According to one or more embodiments, the insert defines an inwardly facing slope for channeling liquids towards the drainage opening of the fountain drink dispenser.

According to one or more embodiments, the panel defines a drainage opening assembly that is configured to be generally aligned with the drainage opening of the fountain drink dispenser when the insert is received within the trough of the fountain drink dispenser.

According to one or more embodiments, the drainage opening assembly defines a plurality of grate slots for capturing particles from passing into the drainage opening of the fountain drink dispenser.

According to one or more embodiments, the drainage opening assembly defines one of more downwardly extending wings configured for being received in the drainage opening of the fountain drink dispenser.

According to one or more embodiments, the drainage opening assembly defines one or more shoulders configured for capturing particles from passing into the drainage opening of the fountain drink dispenser.

According to one or more embodiments, a bottom facing surface of the insert defines one or more drainage channels that converge into the drainage assembly opening for channeling liquid thereto.

According to one or more embodiments, the drainage assembly opening defines a recess for receiving and capturing therein particles from passing into the drainage opening of the fountain drink dispenser.

According to one or more embodiments, the liquid soluble material comprises at least one of an insecticide, pesticide, degreaser, and aromatic treatment.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a perspective view of a perspective view of a fountain drink dispenser having a device installed within a trough of the dispenser for providing treatment to the dispenser trough according to one or more embodiments disclosed herein;

FIG. 2 is a top facing perspective view of a device for providing treatment to a trough of a drink dispenser according to one or more embodiments disclosed herein;

FIG. 3 is a top facing, exploded perspective view of a device for providing treatment to a trough of a drink dispenser according to one or more embodiments disclosed herein;

FIG. 4 is a bottom facing perspective view of a device for providing treatment to a trough of a drink dispenser according to one or more embodiments disclosed herein;

FIG. 5 is a bottom facing, exploded perspective view of a device for providing treatment to a trough of a drink dispenser according to one or more embodiments disclosed herein; and

FIG. 6 is a side view of a device for providing treatment to a drink dispenser, particularly for being received in a drainage pipe of a drink dispenser according to one or more embodiments disclosed herein.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

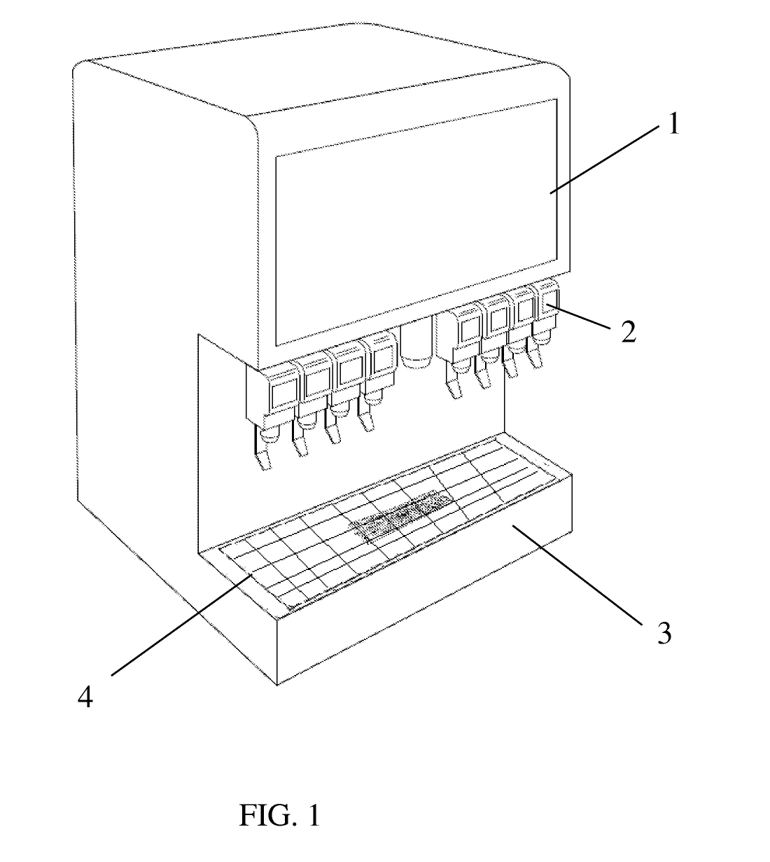

FIG. 1 illustrates a drink dispenser, which is illustrated for example purposes only as a soda dispenser 1. The soda dispenser 1 includes one or more dispensing units 2 that are configured for dispensing a selected drink into a cup or similar container. Any spilled liquid is caught within trough 3 which is fluidly engaged with a drainage outlet pipe. The dispenser 1 is illustrated as a soda dispenser, but any dispenser may be employed. For example, a beer or other drink dispenser may be employed. Additionally, dispensers such as those now used with a single dispensing unit having a touch screen where a user can select the desired drink to be dispensed.

A device 10 is provided for being received within the trough 3 as illustrated in FIG. 1. In this manner, the device 10 may have a cross-section that corresponds to the cross-section of trough 3 so that the device 10 is engageably received within the trough 3, or alternatively, is smaller than the trough 3 as illustrated in FIG. 1. In this manner, the device 10 can be formatted into any appropriately configured shape to fit any dispenser having any shape. A grate cover 4 may be provided such that device 10 fits between grate cover 4 and a surface of the trough 3.

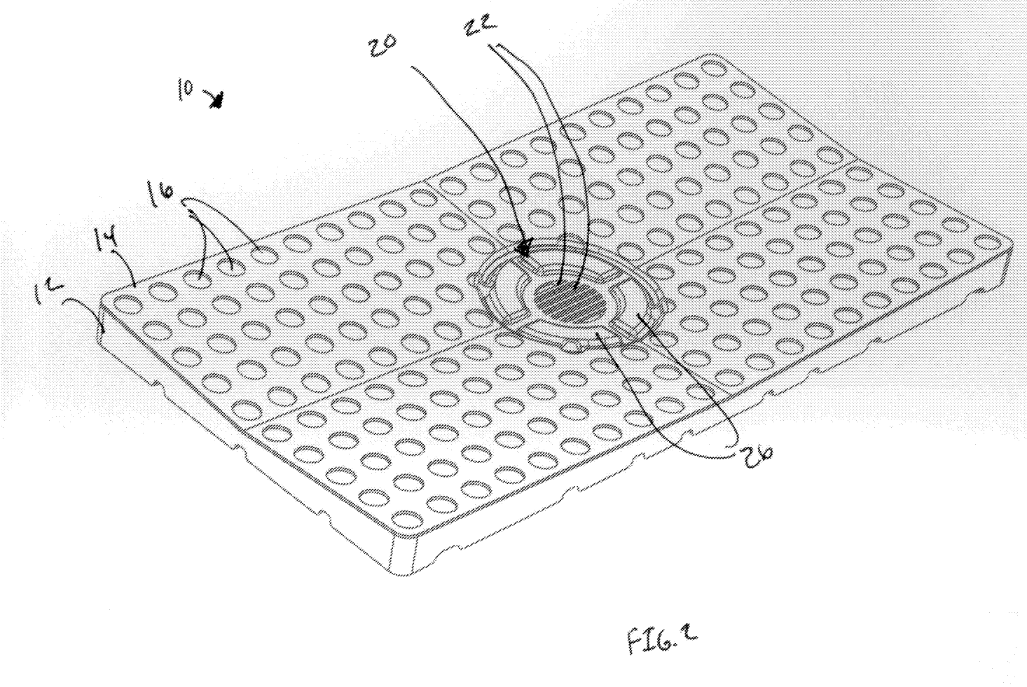

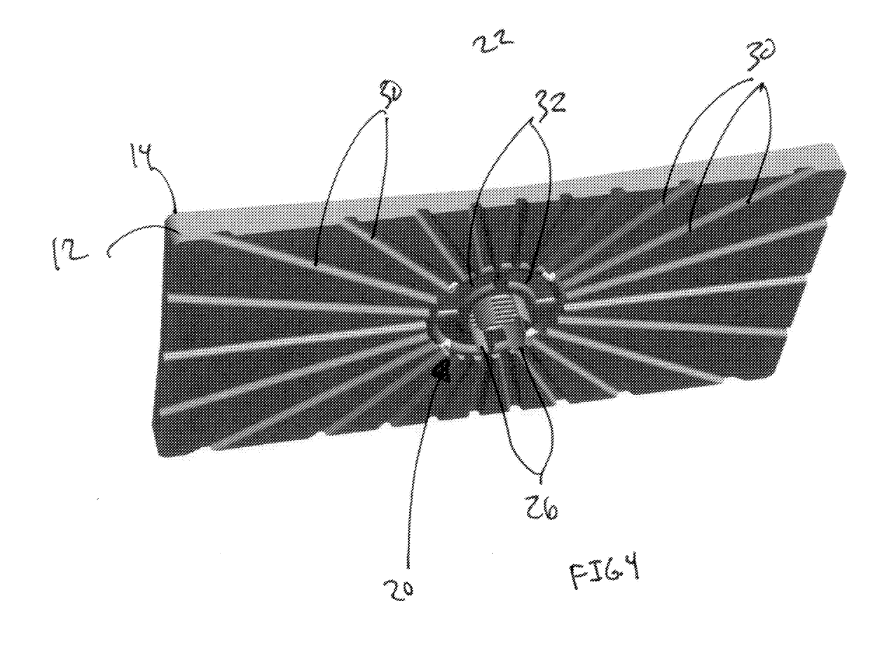

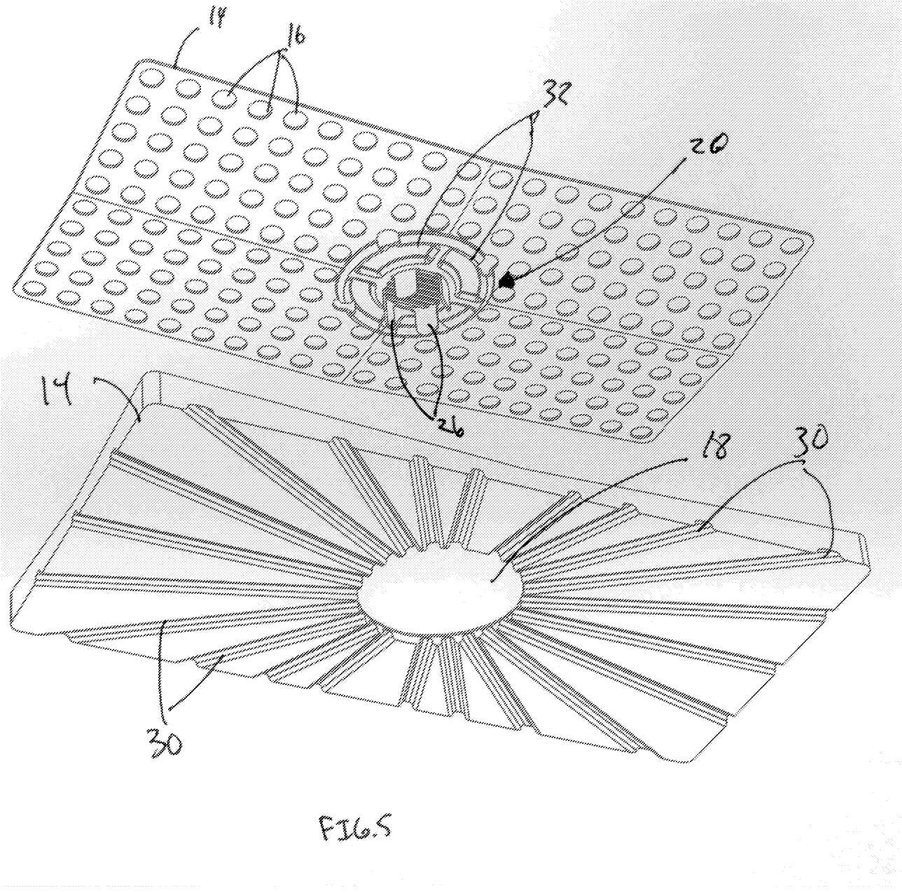

Device 10 will now be described with further reference to FIGS. 2 through 5. The device 10 may include an insert 12 that is sized to be received within a trough 3 of the fountain drink dispenser 1. Insert 12 may be a liquid soluble insert configured for releasing aromatic or other treatments to the dispenser 1. The insert 12 is selectively sized to be received within any sized trough 3 of a drink dispenser 1. The insert 12 may include one or more treatment materials such as, for example, an insecticide, a pesticide, a fungicide, a degreaser, and an aromatic treatment device. The insert 12 may be liquid soluble such that spilled liquids from the dispenser 1 dissolve the insert 12. The insert 12 may take on any appropriately configured dimension, such as height, and may be configured to last a predetermined period of time before replacement is warranted.

The insert 12 may further define an opening 18 at a medial portion thereof. The opening 18 is shown as having a circular cross-section but is not so limited. The device 10 may further include a panel 14 that may be selectively engaged with the insert 12. The panel 14 may define a plurality of apertures 16 that allow flowthrough of spilled liquid from the fountain drink dispenser 1 into the insert 12. The panel 14 may be formed from a plastic or metal. The panel 14 may define as many or as few of a plurality of apertures 16 having any appropriately configured shape and orientation as desired. Panel 14 may also be provided with one or more aromatic treatment properties, such as, for example, having injection molded aromatic treatment material provided therein during the injection molding process.

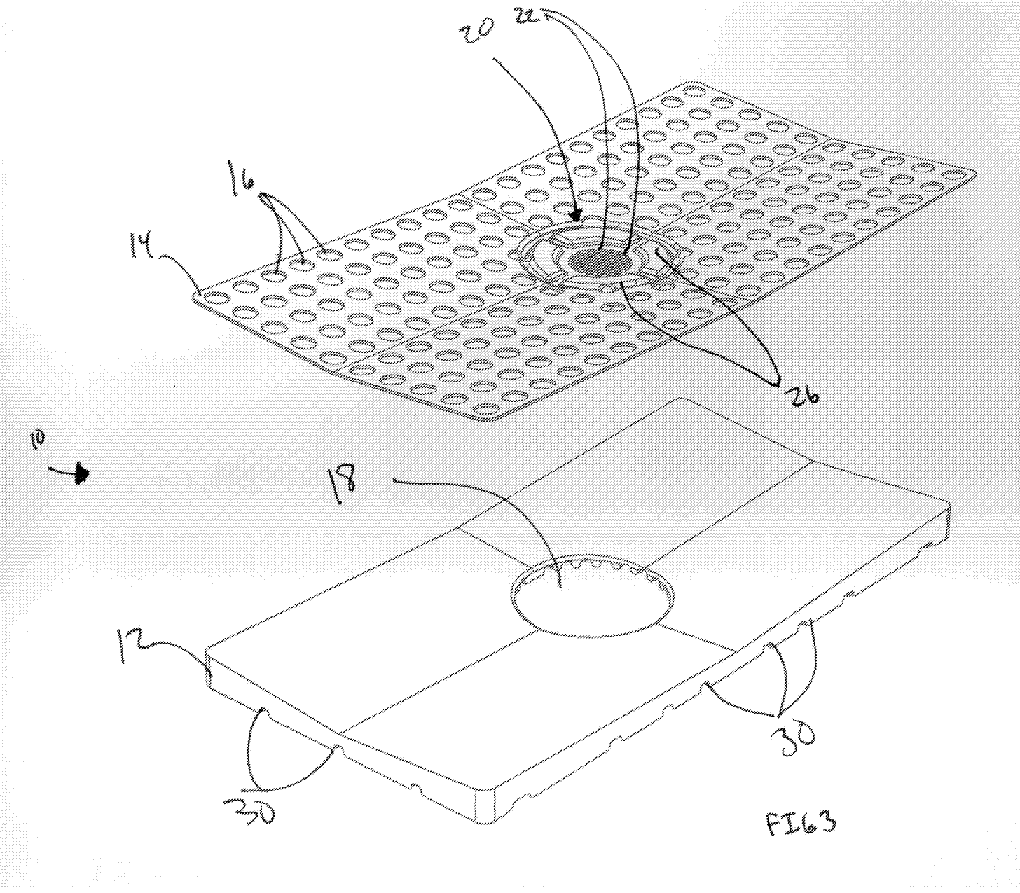

The insert 12 may define an inwardly facing slope for channeling liquids towards the drainage opening of the fountain drink dispenser 1. This is best illustrated in FIGS. 2 and 3. The insert 12 and panel 14 may both define the inwardly facing slope. The inwardly facing slope may be any appropriately configured sloping. The sloping is exaggerated in FIGS. 2 and 3 in order to clearly show this feature. Sloping of insert 12 may not necessarily be required in some embodiments.

The panel 14 may define a drainage opening assembly 20 that is configured to be generally aligned with the drainage opening of the fountain drink dispenser 1 when the insert 12 is received within the trough 3 of the fountain drink dispenser 1. The drainage opening assembly 20 may be selectively engaged with the panel and attached to the panel by any variety of manners, such as having a locking assembly, a screw assembly, an interference fit, and the like. Additionally, the drainage opening assembly 20 is configured for being received within opening 18 of the insert 12. In this manner, the drainage opening assembly 20 may take on any desired shape and orientation and the opening 18 may be provided to have a corresponding shape and orientation. The drainage opening assembly 20 may define a plurality of grate slots 22 for capturing particles from passing into the drainage opening of the fountain drink dispenser. Alternatively, any appropriately configured slot, opening, aperture, and the like may be provided in the drainage opening assembly 20 to capture particles from passing into the drainage opening of the fountain drink dispenser. These particles may be food, ice, or liquid soluble material of the insert 12.

The drainage opening assembly 20 may define one of more downwardly extending wings 24 that are configured for being received in the drainage opening of the fountain drink dispenser 1. Alternatively, a cylindrical sleeve may be employed in place of wings 24, though one of the advantageous aspects of wings 24 is that they can be flexibly received within the drainage opening of the fountain drink dispenser 1. The drainage opening assembly 20 may define one or more shoulders 26 that are configured for capturing particles from passing into the drainage opening of the fountain drink dispenser.

In one or more embodiments, a bottom facing surface of the insert 12 may define one or more drainage channels 30 that converge into the drainage assembly opening 20 for channeling liquid thereto before passing into the dispenser outlet. The drainage assembly opening may define a recess 32 for receiving and capturing therein particles from passing into the drainage opening of the fountain drink dispenser 1.

In one or more embodiments, engagement members besides or in addition to wings 24 may be provided. For example, suction cups may be provided on bottom facing surfaces of insert 12 for suctioning the insert 12 to the trough 3 of the dispenser 1.

In one or more embodiments, the following additional features may also be incorporated as an insert: a basket having a treatment material, a sponge having a treatment material, semi-rigid blocks having a treatment material, netting in place of insert 12 and having a treatment material, a screw in assembly, a twist in assembly, a snap in assembly, a coupling assembly, a drip feeder, a wafer, and a spring loaded insert.

One or more methods for providing treatment to a drink dispenser are disclosed herein. The method may include removing a grate cover from a drink dispenser trough, if a grate cover is provided. The method may also include providing an insert having one or more treatment materials in a trough of the drink dispenser. The insert may be any insert disclosed herein, and, particularly, any device that is sized to be received within a trough and configured for applying one or more treatment materials. The method may include engaging the insert with the trough. This engagement may be by any engaging member. The insert may be placed in the center of the trough, or placed on each end. One or more inserts may be placed in a given trough. The method may include repositioning the grate cover into engagement with the trough.

In one or more embodiments, the device could be formed by providing a thin flat bag that has a weave of material that allows permeation of liquid but would not allow permeation of the solid chemical until it has been diluted and liquified. In these one or more embodiments, the device would may include some locating feature relative to the drainage opening of the dispenser or sink to keep it positioned such as suction cups as described herein. As liquid dilutes or dissolves the device, the device may go flat from erosion of the material, thus indicating that the device needs to be replaced. A graphic that reads “Replace Now” could be exposed on the inside face of the bottom fabric (if the fabric was translucent) that would be exposed once it is no longer hidden by the solid chemical.

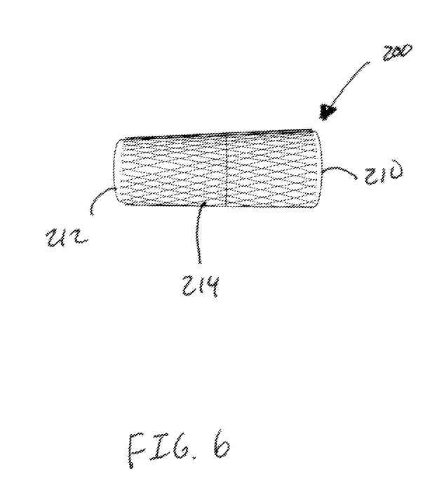

A treatment device is illustrated in FIG. 6 and generally designated 200. The treatment device 200 is configured for being received in the outlet drain of a drink dispenser 1. The treatment device 200 may include a first treatment material 210 and a second treatment material 212. The first and second treatment materials 210 and 212 may be aroma treatment, herbicide, fungicide, degreaser and the like. A webbing 214 may be provided for capturing the treatment materials 210 and 212, particularly in instances where treatment materials 210 and 212 are liquid soluble. In this manner, webbing 214 may continue to capture dissolving treatment materials 210 and 212 for a more prolonged time. Webbing 214 may further include a handle or the like for grabbing the remnants of treatment device 200 and removing from the outlet drain of a drink dispenser.

Device 10 may also be placed into a sink basin or floor sink drain for applying treatment thereto. In this manner, device 10 may not have to be used with a drink dispenser and may be used in any situation in which liquid flows and sanitation is desired.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A device for use with a drink dispenser, comprising:
an insert sized to be received within a trough of a drink dispenser,
wherein the insert defines one or more treatment materials for providing treatment to the drink dispenser.

2. The device according to claim 1, further comprising a panel that nests onto the insert configured for channeling liquid into a drainage opening of the drink dispenser.

3. The device according to claim 1, wherein the insert is a liquid soluble treatment material.

4. The device according to claim 3, wherein the panel defines one or more apertures that allow flow of liquid into the liquid soluble treatment material.

5. The device according to claim 2, wherein the insert defines an inwardly facing slope for channeling liquids towards the drainage opening of the drink dispenser.

6. The device according to claim 2, wherein the panel defines a drainage opening assembly that is configured to be generally aligned with the drainage opening of the drink dispenser when the insert is received within the trough of the drink dispenser.

7. The device according to claim 6, wherein the drainage opening assembly defines a plurality of grate slots for capturing particles from passing into the drainage opening of the drink dispenser.

8. The device according to claim 6, wherein the drainage opening assembly defines one of more downwardly extending wings configured for being received in the drainage opening of the drink dispenser.

9. The device according to claim 6, wherein the drainage opening assembly defines one or more shoulders configured for capturing particles from passing into the drainage opening of the drink dispenser.

10. The device according to claim 1, wherein a bottom facing surface of the insert defines one or more drainage channels that converge into the drainage assembly opening for channeling liquid thereto.

11. The device according to claim 10, wherein the drainage assembly opening defines a recess for receiving and capturing therein particles from passing into the drainage opening of the drink dispenser.

12. The device according to claim 1, wherein the bottom facing surface of the insert defines one or more engagement members for engaging the insert to the trough.

13. The device according to claim 1, wherein the treatment characteristic comprises at least one of an insecticide, pesticide, degreaser, and aromatic treatment.

14. A device for use with a drink dispenser, comprising:
an insert having one or more treatment materials and that is sized to be received within a trough of a drink dispenser; and
a panel engaged with the insert and defining a plurality of apertures that allow flowthrough of spilled liquid from the drink dispenser into the insert.

15. The device according to claim 14, wherein the insert defines an inwardly facing slope for channeling liquids towards the drainage opening of the drink dispenser.

16. The device according to claim 15, wherein the panel defines a drainage opening assembly that is configured to be generally aligned with the drainage opening of the drink dispenser when the insert is received within the trough of the drink dispenser.

17. The device according to claim 16, wherein the drainage opening assembly defines a plurality of grate slots for capturing particles from passing into the drainage opening of the drink dispenser.

18. The device according to claim 16, wherein the drainage opening assembly defines one of more downwardly extending wings configured for being received in the drainage opening of the drink dispenser.

19. The device according to claim 16, wherein the drainage opening assembly defines one or more shoulders configured for capturing particles from passing into the drainage opening of the drink dispenser.

20. The device according to claim 14, wherein a bottom facing surface of the insert defines one or more drainage channels that converge into the drainage assembly opening for channeling liquid thereto.

21. The device according to claim 20, wherein the drainage assembly opening defines a recess for receiving and capturing therein particles from passing into the drainage opening of the drink dispenser.

22. The device according to claim 14, wherein the insert defines one or more engagement members on a bottom surface thereof for engaging the insert to the trough.

23. The device according to claim 14, wherein the liquid soluble material comprises at least one of an insecticide, pesticide, degreaser, and aromatic treatment.

24. A method for providing treatment to a drink dispenser, comprising:
providing an insert having one or more treatment materials in a trough of the drink dispenser; and
engaging the insert with the trough; and
passing liquid through the insert in order to provide treatment materials to the drink dispenser.
